(19) United States
(12) Patent Application Publication
(10) Pub. No.: US 2007/0033656 A1
(43) Pub. Date: Feb. 8, 2007

(54) Access control technique for resolving grants to users and groups of users on objects and groups of objects

(75) Inventors: Bruce Benfield, Austin, TX (US); Mary Claire Lehner, San Jose, CA (US); Erik Bruce Underkofler, Austin, TX (US); Ningning Wang, Round Rock, TX (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation

(21) Appl. No.: 11/196,839

(22) Filed: Aug. 2, 2005

(51) Int. Cl. H04L 9/32; H04N 7/16; H04L 9/00; G06K 9/00; G06F 17/30; G06F 7/04; H03M 1/68; H04K 1/00

(52) U.S. Cl. 726/27; 713/165; 713/167; 726/28; 726/29; 726/2

(57) ABSTRACT

Various embodiments of a method, system and article of manufacture resolve access to a specific principal on a particular resource. A set of candidate access rights to at least one principal on at least one resource is determined based on at least one grant. Any candidate access right for which there is another candidate access right to a same principal on a resource which is closer to the particular resource along a same route is eliminated from the said set of candidate access rights. Any candidate access right for which there is another candidate access right on a same resource to a principal which is closer to the specific principal along a same route is eliminated from the set of candidate access rights. Access is provided in accordance with a most permissive access level of the set of candidate access rights.

### BACKGROUND OF THE INVENTION

1.0 Field of the Invention

This invention relates to access control, and in particular, to an access control technique for resolving grants to users and groups of users on objects and groups of objects.

2.0 Description of the Related Art

In a computer system, users are granted access rights as to which objects, such as files and folders, they may access. Users may be grouped into an access group. An access group has one or more users which are members. Access rights can be granted to individual users and to access groups. In addition, an access group can be a member of one or more other access groups. Objects may be grouped into collections, and a collection has one or more objects which are members. Access rights can also be granted to individual objects and to collections. A collection can also be a member of one or more other collections. A record of a grant is made when a grant occurs, and is removed when a “revoke” occurs. An access control system typically manages the access rights. To determine the access rights that a user has to an object, in addition to considering the user and the object, the access control system considers the access groups of which the user is a member and the collections of which the object is a member.

Multiple levels of access may be granted. In one conventional access control system, each level of access granted encompasses a set of abilities, such as get properties, set properties and delete object, rather than a single ability, and the levels of access have a strict ordering such that the abilities of each level are a superset of the abilities of the next lower level. For example, the levels may be—“Full,” “Write,” “Read,” and “None.” “Full” level access provides the ability to delete plus all the abilities of “Write” level access. “Write” level access provides the ability to set properties plus the abilities of “Read” level access. “Read” level access provides the ability to get properties plus all the abilities of “None” level access. “None” level access provides no abilities.

Multiple grants may apply when a user attempts to access a particular object. For example, a specific user may have been granted “Write” level access on a collection containing a particular object, and an access group of which the specific user is a member may have been granted “Read” access on the particular object.

In general, it is desirable that access granted to a specific user takes precedence over access granted to an access group, and also that access granted on a particular object takes precedence over access granted on a collection. However, these two principles can come into conflict when one grant is to a specific user on a collection, and another grant is on a particular object to an access group. Therefore there is a need for an improved technique to resolve access.

### SUMMARY OF THE INVENTION

To overcome the limitations in the prior art described above, and to overcome other limitations that will become apparent upon reading and understanding the present specification, various embodiments of a method, computer system, and article of manufacture to resolve access to a specific principal on a particular resource are provided. A principal set comprises a specific principal and any principals of which the specific principal is a member. A resource set comprises a particular resource and any resources of which the particular resource is a member. A set of candidate access rights to at least one principal on at least one resource is determined based on at least one grant. Any candidate access right for which there is another candidate access right to a same principal on a resource which is closer to the particular resource along a same route is eliminated from the set of candidate access rights. Any candidate access right for which there is another candidate access right on a same resource to a principal which is closer to the specific principal along a same route is eliminated from the set of candidate access rights. Access is provided in accordance with a most permissive access level of the set of candidate access rights.

In this way, a technique is provided to resolve access.

### BRIEF DESCRIPTION OF THE DRAWINGS

The teachings of the present invention can be readily understood by considering the following description in conjunction with the accompanying drawings, in which:

FIG. 1 depicts a flowchart of an embodiment of a technique for resolving access to a specific principal and a particular resource based on a set of grants;

FIG. 2 depicts a diagram which is used to illustrate an embodiment of a technique for determining the level of access that a specific principal named User1 has on a particular resource named Object1;

FIG. 3 depicts an exemplary set of all candidate access rights that could apply to the specific principal and the particular resource based on the access table of Table 1 and the diagram of FIG. 2 in which the candidate access rights were identified in accordance with FIG. 1, and also illustrates the elimination steps of FIG. 1; and

FIG. 4 depicts an illustrative computer system which uses various embodiments of the present invention.

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to resolve which grant, among multiple grants that could apply to a principal and a resource, takes precedence in a computer system. Various embodiments of a method, computer system and article of manufacture to resolve access to a specific principal on a particular resource are provided. A principal set comprises a specific principal and any principals of which the specific principal is a member. A resource set comprises a particular resource and any resources of which the particular resource is a member. A set of candidate access rights to at least one principal on at least one resource is determined based on at least one grant. Any candidate access right for which there is another candidate access right to a same principal on a resource which is closer to the particular resource along a same route is eliminated from the set of candidate access rights. Any candidate access right for which there is another candidate access right on a same resource to a principal which is closer to the specific principal along a same route is eliminated from the set of candidate access rights. Access is provided in accordance with a most permissive access level of the set of candidate access rights.

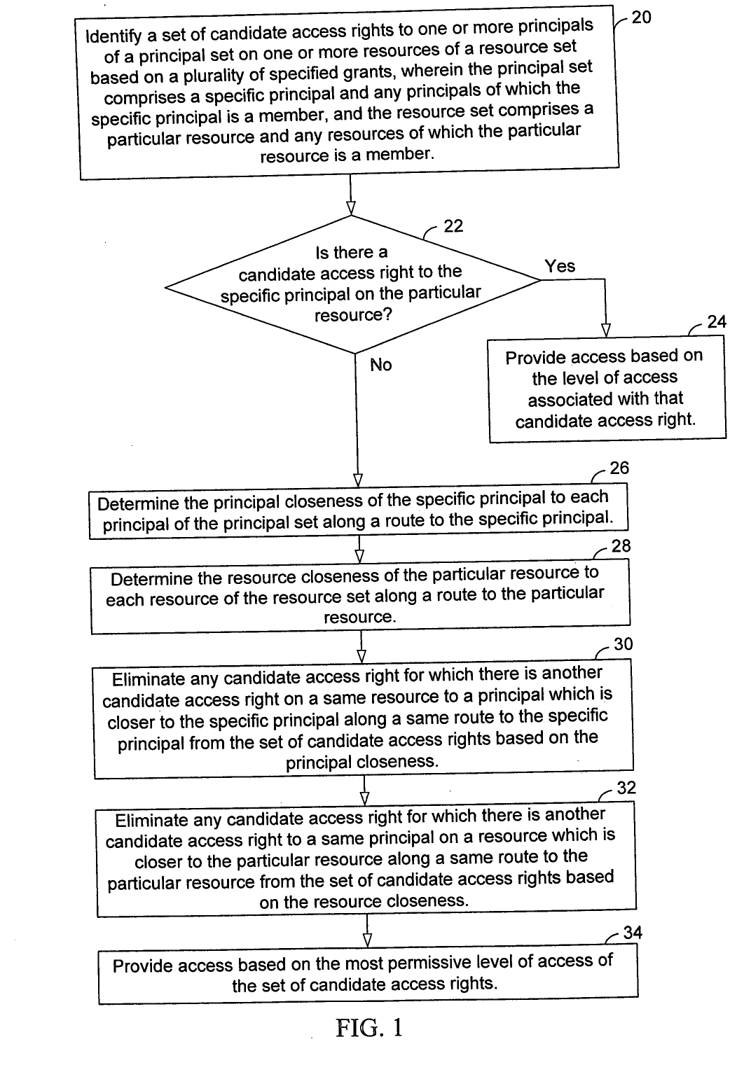

FIG. 1 depicts a flowchart of an embodiment of a technique for resolving access to a specific principal on a particular resource based on a set of grants. In various embodiments, a principal comprises one from a group consisting of a user and an access group. In some embodiments, a principal comprises one from a group consisting of a user, an access group and the public, that is, all users. A principal set comprises a specific principal and any principals of which the specific principal is a member directly or indirectly. For example, a specific user plus the access groups of which the specific user is a member, either directly or indirectly, constitute a principal set. In another example, a specific access group plus the access groups of which the specific access group is a member, either directly or indirectly, constitute a principal set.

In various embodiments, a resource comprises one from a group consisting of an object and a collection. In some embodiments, a resource comprises one from a group consisting of an object, a collection and all objects. A resource set comprises a particular resource and any resources of which the particular resource is a member either directly or indirectly. For example, a particular object plus the collections of which the particular object is a member, either directly or indirectly, constitute a resource set. In another example, a particular collection plus the collections of which the particular collection is a member, either directly or indirectly, constitute a resource set. P In various embodiments, an access table contains grants to one or more principals on one or more resources with specified levels of access. Typically, the grants are defined by a user.

In step 20, a set of candidate access rights to the principals of the principal set on the resources of the resource set are identified based on the specified grants, wherein the principal set comprises a specific principal and any principals of which the specific principal is a member, either directly or indirectly, and the resource set comprises a particular resource and any resources of which the particular resource is a member, either directly or indirectly.

Step 22 determines whether there is a candidate access right to the specific principal on the particular resource. If so, in step 24, access is provided in accordance with the access level of that candidate access right.

In response to step 22 determining that there is no candidate access right to the specific principal on the particular resource, in step 26, the principal closeness of the specific principal to each principal of the principal set is determined along a route to the specific principal. In step 28, the resource closeness of the particular resource to each resource of the resource set is determined along a route to the particular resource.

In step 30, any candidate access right for which there is another candidate access right on a same resource to a principal which is closer to the specific principal resource along a same route to the specific principal is eliminated from the set of candidate access rights based on the principal closeness. In step 32, any candidate access right for which there is another candidate access right to a same principal on a resource which is closer to the particular resource along a same route to the particular resource is eliminated from the set of candidate access rights based on the resource closeness. In some embodiments, step 32 is performed prior to step 30. In step 34, access is provided based on the most permissive candidate access right from the set of candidate access rights.

Various steps of FIG. 1 will now be discussed in further detail. In step 20, a set of candidate access rights to the principals of the principal set on the resources of the resource set are identified based on the specified grants. All possible candidate access rights to the specific principal and the other principals of the principal set on the particular resource and the other resources of the resource set are identified. The set of candidate access rights comprises a record for each identified candidate access right. In various embodiments, the record comprises the principal identifier, the closeness of the principal to the specific principal, the type of access granted, the resource identifier, and the closeness of the resource to the particular resource. In some embodiments, the principal identifier is a principal name, and the resource identifier is a resource name. However, the principal identifier and resource identifiers are not meant to be limited to a principal name and a resource name, and other types of principal identifiers and resource identifiers may be used, respectively.

In various embodiments, one or more routes are also identified based on the membership of the principals and resources. In some embodiments, a route is associated with one or more principals which directly and/or indirectly provide the specific principal with membership in another principal. Since each principal can be a member of one or more other principals, a principal may have an indirect membership in another principal via more than one route. For example, user1 is the specific principal; and access groups “A,” “B” and “C” are other principals. Suppose that user1 is a member of access group “A” and access group “B,” and that both access group “A” and access group “B” are members of access group “C.” A principal set comprises userl and access groups “A,” “B” and “C.” User1 is indirectly a member of access group “C” via two routes, via access group “A” and access group “B.” Therefore, one route comprises user1, access group “A” and access group “C”; and, another route comprises user1, access group “B” and access group “C.”

In various embodiments, a route is associated with one or more resources which directly and/or indirectly provide the particular resource with membership in another resource. Since each resource can be a member of one or more other resources, a particular resource may have indirect membership in another resource via more than one route. For example, object one is a particular resource, and collections “A,” “B” and “C” are other resources. Suppose that object one is a member of collection “A” and collection “B,” and that both collection “A” and collection “B” are members of collection “C.” A resource set comprises object one and collections “A,” “B” and “C.” Object one is a member of collection “C” via two indirect routes, via collection “A” and collection “B.” Therefore, one route comprises object one, collection “A” and collection “C;” and, another route comprises object one, collection “B” and collection “C.”

Thus, in some embodiments, if a candidate access right record defines a candidate access right to a principal of which a specific principal is a member via more than one route, the single candidate access right record is replaced with a candidate access right record for each route. If the candidate access right record defines a candidate access right on a resource of which the particular resource is a member via more than one route, the single candidate access right record is replaced with a candidate access right record for each route. In other words, in some embodiments, the single grant from the access table is associated with one record for each route in the set of candidate access rights.

In step 26, the principal closeness of the specific principal to each principal of the principal set along a specific route is determined. A principal closeness of zero is assigned to the specific principal. Each principal of which the specific principal is a directly a member is assigned a principal closeness of one. Each principal having a member with a principal closeness of one, is assigned a principal closeness of two. In general, each principal having a member with a principal closeness of n is assigned a principal closeness of n+1. The principal closeness of the principals and of the specific principal is recorded in the set of candidate access rights.

In step 28, the resource closeness of the particular resource to each resource of the resource set along a specific route is determined. Any resource of which the particular resource is directly or indirectly a member is analyzed to determine the resource closeness of each such resource to the particular resource. The particular resource is assigned a resource closeness of zero. Each resource of which the particular resource is a member is assigned a resource closeness of one. Each resource having a member with a resource closeness of n is assigned a resource closeness of n+1. The resource closeness of the resource and the particular resource is recorded in the set of candidate access rights.

In step 30, any candidate access right for which there is another candidate access right on a same resource to a principal which is closer to the specific principal along a same route to the specific principal is eliminated from the set of candidate access rights based on the principal closeness. In various embodiments, each candidate access right of the set of candidate access rights is evaluated for elimination based on the principal closeness. In some embodiments, to eliminate a candidate access right from consideration, that candidate access right is overridden, that is, deleted from the set of candidate access rights. Alternately, the candidate access right is flagged as no longer belonging to the set of candidate access rights.

In step 32, any candidate access right for which there is another candidate access right to a same principal on a resource which is closer to the particular resource along a same route to the particular resource is eliminated from the set of candidate access rights based on the resource closeness. In various embodiments, each candidate access right of the set of candidate access rights is evaluated for elimination. In some embodiments, to eliminate a candidate access right from consideration, that candidate access right is overridden, that is, the associated record of the candidate access right is deleted from the set of candidate access rights. Alternately, the candidate access right is flagged as no longer belonging to the set of candidate access rights.

In step 34, access is provided based on the most permissive access level of the set of candidate access rights. The remaining candidate access right records in the set of candidate access rights are strictly ordered by the levels of access such that the abilities of each level are a superset of the abilities of the next lower level. Among all candidate access rights remaining in the set of candidate access rights, the most permissive candidate access right is selected and used. In various embodiments, the levels of access comprise: “Full,” “Write,” “Read” and “None.” In some embodiments, the levels of access comprise: “Full,” “Write,” “Read” and “Identity,” where the “Identity” access right is the most restrictive access right and provides the ability to view an object's properties, such as the object's name and the object's owner, but not view the contents of the object.

Various embodiments of the technique of the flowchart of FIG. 1 are directed to an access control system that has users, access groups, objects, collections and levels of access. The technique of FIG. 1 does not accommodate an access control system in which declarations can be made that certain types of access are denied to users and to groups and the resolution of access considers both declarations of denied access and declarations of permitted access.

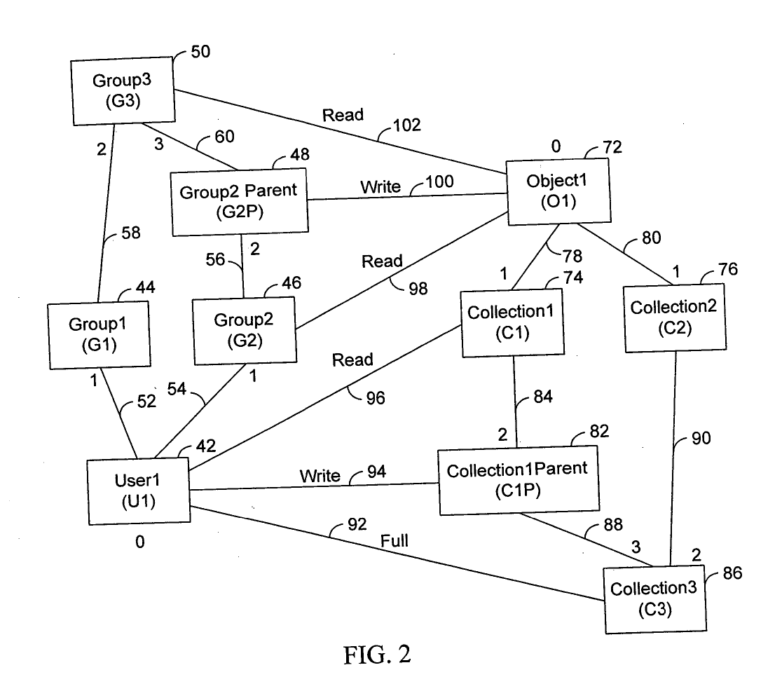

FIG. 2 depicts a diagram which is used to illustrate an embodiment of a technique for determining the level of access that a specific principal named User1 has on a particular resource named Object1. Table 1 below contains the specific access grants associated with the diagram of FIG. 2. Table 1 has a principal column, a type of access column and a resource column. The principal column specifies a principal, that is, an access group or a user name. The resource column specifies an object or collection for which the principal is granted access. The type of access column specifies the type of access granted to the principal on the resource, such as Full, Write, Read and None. In this example, the specific principal is User1 and the particular resource is Object1.

TABLE 1
Access table

| Principal | Type of access | Resource |
|---|---|---|
| Group2 | Read | Object1 |
| Group2Parent | Write | Object1 |
| Group3 | Read | Object1 |
| User1 | Read | Collection1 |
| User1 | Write | Collection1Parent |
| User1 | Full | Collection3 |

As shown in FIG. 2, the specific principal, User1, 42 is a member of two access groups, Group1 44 and Group2 46. Group2 46 is a member of a larger access group named Group2Parent 48. Group1 42 and Group2Parent 48 are both members of a larger access group named Group3 50. Lines 52 and 54 indicate that User1 is a member of Group1 and Group2, respectively. Line 56 indicates that Group2 is a member of Group2Parent. Therefore User1 is indirectly a member of Group2Parent. Line 58 indicates that Group1 is a member of Group3. Line 60 indicates that Group2Parent is a member of Group3. The principal set comprises User1, Group1, Group2, Group2Parent and Group3.

Object1 72 is a member of two collections, Collection1 74 and Collection2 76, as indicated by lines 78 and 80, respectively. Collection1 74 is a member of a larger collection named Collection1Parent 82, as indicated by line 84. Collection1Parent 82 and Collection2 76 are both members of a larger collection named Collection3 86, as indicated by lines 88 and 90, respectively. For example, Object1 is a direct member of Collection1 and indirectly a member of Collection1 Parent. The resource set comprises Object1, Collection1, Collection2, Collection1Parent and Collection3.

In accordance with Table 1, User1 42 has been granted Full access to Collection3 86, Write access to Collection1Parent 82, and Read access to Collection1 74, as shown by lines 92, 94 and 96, respectively. Group2 46 has been granted Read access to Object1 72 as indicated by line 98. Group2Parent 48 has been granted Write access to Object1 72 as indicated by line 100. Group3 50 has been granted Read access to Object1 72 as indicated by line 102.

The numbers next to each block indicate either the principal closeness to the specific principal, User1, or the resource closeness to the particular resource, Object1, via a route to the specific principal or particular resource, respectively.

To identify a route among principals, the membership of each principal, such as an access group, is examined. For example, because User1 is a member of Group1 and Group1 is a member of Group3, route one comprises User1 42, Group1 44 and Group3 50. Route two comprises User1 42, Group2 46, Group2Parent 48 and Group3 50. For example, Group3 50 has a principal closeness of two via route one, and a principal closeness of three via the route two. To identify a route among resources, the membership of each resource, such as a collection, is examined. Because Object1 is a member of Collection1, and Collection1 is a member of Collection1Parent, and Collection1Parent is a member of Collection3, route three comprises Object1 72, Collection1 74, Collection1Parent 82 and Collection3 86. Route four comprises Object1 72, Collection2 76 and Collection3 86. Collection3 86 has a closeness of three via route three and a resource closeness of two via route two.

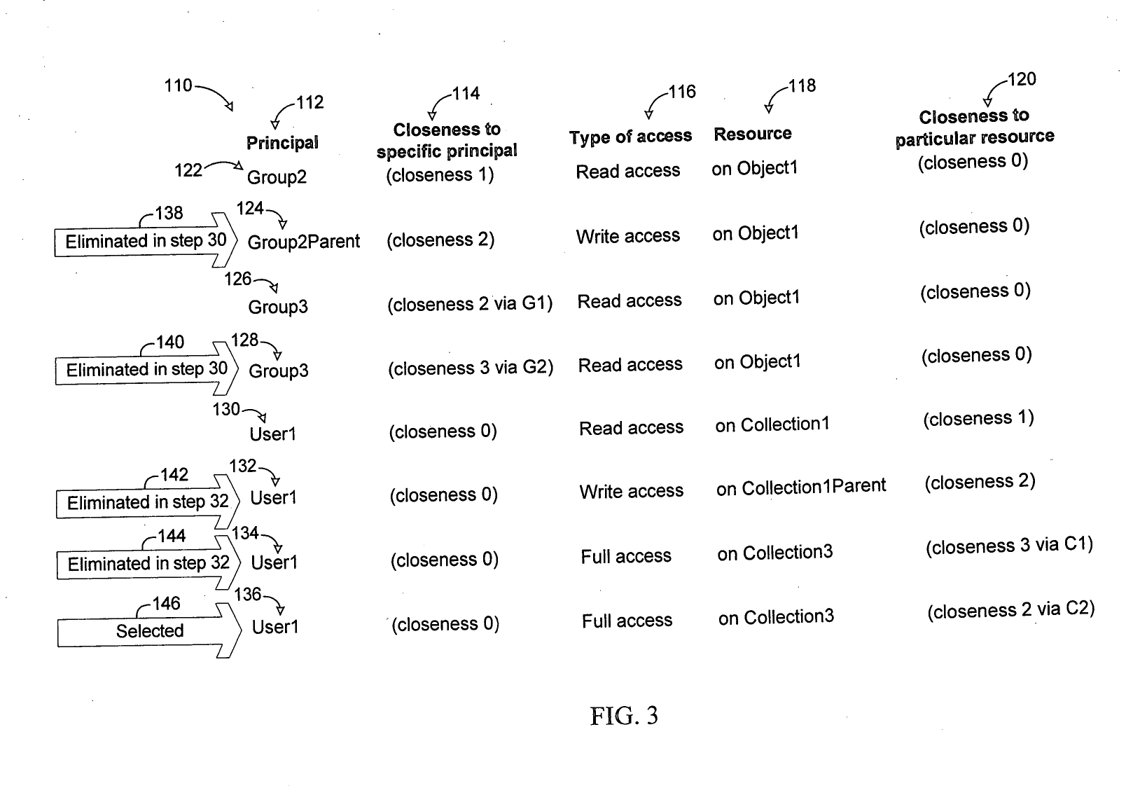

FIG. 3 depicts the set of all candidate access rights 110 that could apply to the specific principal and the particular resource based on the access table of Table 1 and the diagram of FIG. 2 in which the candidate access rights were identified in accordance with step 20 of FIG. 1, and also illustrates the elimination steps of FIG. 1. The set of candidate access rights has a principal column 112, a closeness to specific principal column 114 which contains the principal closeness, a type of access column 116, a resource column 118, and a closeness to particular resource column which contains the resource closeness. The set of all candidate access rights is based on the six explicit grants of Table 1 and contains eight candidate access rights, and therefore eight records. A first candidate access right 122 is based on the grant of read access to Group2 on Object1. A second candidate access right 124 is based on the grant of write access to Group2Parent on Object1. Another grant from the access table is for read access to Group3 on Object1. Because there are two routes to Group3, Group3 is associated with two candidate access rights, and therefore two records rather than a single candidate access right, and therefore a single record, respectively. Therefore a third candidate access right 126 is generated for read access to Group3 on Object1 via Group1 (G1), and a fourth candidate access right 128 is generated for read access to Group3 on Object1 via Group2. A fifth candidate access right 130 is generated based on the grant of read access between User1 on Collection1. A sixth candidate access right 132 is generated based on the grant of write access to User1 on Collection1 Parent. Another grant is for full access to User1 on Collection3. Because there are two routes to Collection3, Collection3 is associated with two candidate access rights, and therefore two records, rather than a single candidate access right and therefore a single record, respectively. A seventh candidate access right 134 is for full access to User1 on Collection3 via the Collection1 (C1) route. An eighth candidate access right 136 is for full access to User1 on Collection3 via the Collection2 (C2) route.

In accordance with steps 26 and 28 of FIG. 1, the principal closeness of each principal to the specific principal and the resource closeness of each resource to the particular resource are indicated in the set of all candidate access rights of FIG. 3. For example, the specific principal, User1, has a principal closeness of zero to itself. Group1 has a principal closeness of one to User1. Group3 has a principal closeness of two to User1 via route one. Group3 also has a principal closeness of three to User1 via route two. Object1 has a resource closeness of zero to itself. Collection1 has a resource closeness of one to Object1. Collection3 has a resource closeness of two to Object1 via route four. Collection3 also has a resource closeness of three to Object1 via route three.

Arrows 138 and 140 indicate which candidate access rights are eliminated in accordance with step 30 of FIG. 1. Route one comprises User1, Group2, Group2Parent and Group3. Route two comprises User1, Group1 and Group3. Along route two, since there is no candidate access right to User1 on Object1, and to Group1 on Object1, the candidate access right 126 to Group3 on Object1 via Group1 (G1) is not eliminated. Along route one, the candidate access right 128 to Group3 on Object1 has a principal closeness of 3, and the candidate access right 124 to Group2Parent on Object1 has a principal closeness of 2. Since the principal closeness of Group2Parent is less than that of Group3 along the same route, candidate access right 128 is eliminated. Along route one, the candidate access right 124 to Group2Parent on Object1 has a principal closeness of 2, the candidate access right 122 to Group2 on Object1 has a principal closeness of 1, and since the principals of candidate access rights 122 and 124 are along the same route, candidate access right 124 is eliminated.

Arrows 142 and 144 indicate the candidate access rights that are eliminated in accordance with step 32 of FIG. 1. Candidate access rights 130, 132 and 134 are to the same principal and are along the same route, that is, route three, therefore candidate access rights 132 and 134 are eliminated because the resource closeness of candidate access right 130 to the particular resource, Object1, is less than the resource closeness of candidate access rights 132 and 134 to Object1. Arrow 146 indicates that the access level associated with candidate access right 136 is selected because it is the most permissive access right.

In another embodiment, a user is directly a member of only one group, and a group is directly a member of only one other group. In other words, in this embodiment, a principal is directly a member of only one other principal, and no alternates routes from a specific principal to a containing principal would occur.

In yet another embodiment, a group is not a member of any other group. For example, the closeness to a principal would be zero (grant to the user), one (grant to a group the user is in), or two (grant to public); therefore there would be no alternate routes from a specific principal to a containing principal. In another example, the closeness to a principal would be zero (grant to the user) or one (grant to a group the user is in); therefore there would be no alternate routes from a specific principal to a containing principal.

In another embodiment, an object is directly a member of only one collection, and a collection is a member of only one other collection. In other words, in this embodiment, a resource is directly a member of only one other resource, and there would be no alternate routes from a particular resource to a containing resource.

In yet another embodiment, a collection is not a member of any other collection. For example, the closeness to a resource would be zero (grant on the resource), one (grant on a collection the resource is in), or two (grant on all objects); therefore, there would be no alternate routes from a particular resource to a containing resource. In another example, the closeness to a resource would be zero (grant on the resource) or one (grant on a collection the resource is in); therefore, there would be no alternate routes from a particular resource to a containing resource.

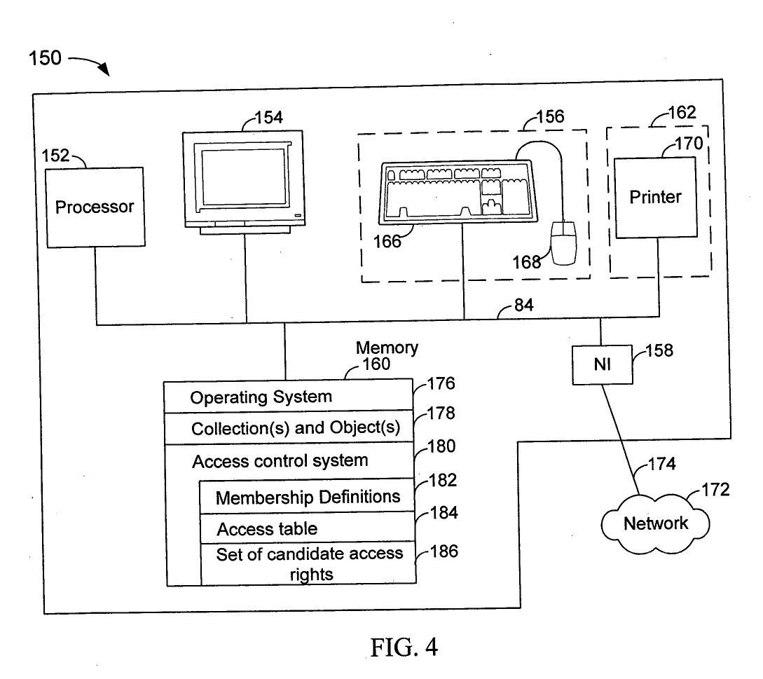

FIG. 4 depicts an embodiment of an illustrative computer system 150 which uses various embodiments of the present invention. The computer system 150 comprises a processor 152, display 154, input interfaces (I/F) 156, communications interface 158, memory 160 and output interface(s) 162, all conventionally coupled by one or more buses 164. The input interfaces 156 comprise a keyboard 166 and a mouse 168. The output interface 162 comprises a printer 170. The communications interface 158 is a network interface (NI) that allows the computer 150 to communicate via the network 172. The communications interface 158 may be coupled to the network 172 via a transmission medium 174 such as a network transmission line, for example twisted pair, coaxial cable or fiber optic cable. In another embodiment, the communications interface 158 provides a wireless interface, that is, the communications interface 158 uses a wireless transmission medium.

The memory 160 generally comprises different modalities, illustratively semiconductor memory, such as random access memory (RAM), and disk drives. In various embodiments, the memory 160 stores an operating system 176, collection(s) and object(s) 178 and an access control system 180. The access control system 180 comprises membership definitions 182, an access table 184 and a set of candidate access rights 186. The membership definitions 182 define groups and collection objects. In various embodiments, the membership definitions 182 and access table 184 is stored in persistent storage and the set of candidate access rights is stored in volatile memory.

In various embodiments, the specific software instructions, data structures and data that implement various embodiments of the present invention are typically incorporated in the access control system 180. Generally, an embodiment of the present invention is tangibly embodied in a computer-readable medium, for example, the memory 160, and is comprised of instructions which, when executed by the processor 152, cause the computer system 150 to utilize the present invention. The memory 160 may store the software instructions, data structures and data for any of the operating system 178 and access control system 180 in semiconductor memory, in disk memory, or a combination thereof. Other computer memory devices presently known or that become known in the future, or combination thereof, may be used for memory 160.

The operating system 176 may be implemented by any conventional operating system such as AIX® (Registered Trademark of International Business Machines Corporation), UNIX® (UNIX is a registered trademark of the Open Group in the United States and other countries), Windows® (Registered Trademark of Microsoft Corporation), Linux® (Registered trademark of Linus Torvalds), Solaris® (Registered trademark of Sun Microsystems Inc.) and HP-UX® (Registered trademark of Hewlett-Packard Development Company, L.P.).

In various embodiments, the present invention may be implemented as a method, computer system, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the code is implemented also encompasses transmission media, such as the network transmission line and wireless transmission media. Thus the article of manufacture also comprises the medium in which the code is embedded. Those skilled in the art will recognize that many modifications may be made to this configuration without departing from the scope of the present invention.

The exemplary computer system illustrated in FIG. 4 is not intended to limit the present invention. Other alternative hardware environments may be used without departing from the scope of the present invention.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method of resolving access to a specific principal on a particular resource, comprising:
determining a set of one or more candidate access rights based on at least one grant to at least one principal on at least one resource, wherein a principal set comprises said specific principal and any principals of which said specific principal is a member either directly or indirectly, and a resource set comprises said particular resource and any resources of which said particular resource is a member either directly or indirectly, each candidate access right being to one of said principals of said principal set on one of said resources of said resource set;
eliminating from said set of candidate access rights any candidate access right for which there is another candidate access right to a same principal on a resource which is closer to said particular resource along a same route to said particular resource;
eliminating from said set of candidate access rights any candidate access right for which there is another candidate access right on a same resource to a principal which is closer to said specific principal along a same route to said specific principal; and
providing access in accordance with a most permissive access level of said set of candidate access rights.

2. The method of claim 1 wherein said eliminating from said set of candidate access rights any candidate access right for which there is another candidate access right to a same principal on a resource which is closer to said particular resource along a same route to said particular resource is based on a resource closeness; and
wherein said eliminating from said set of candidate access rights any candidate access right for which there is another candidate access right on a same resource to a principal which is closer to said specific principal along a same route to said specific principal is based on a principal closeness.

3. The method of claim 2 further comprising:
determining, for each principal of said principal set, said principal closeness of that principal to said specific principal; and
determining, for each resource of said resource set, said resource closeness of that resource to said particular resource.

4. The method of claim 1 wherein each principal comprises one from a group consisting of a specific user and an access group, and each resource comprises one from a group consisting of a particular object and a collection.

5. The method of claim 1 wherein each principal comprises one from a group consisting of a specific user, an access group and public, and each resource comprises one from a group consisting of a particular object, a collection and all objects.

6. The method of claim 1 wherein each principal of said principal set is a member of only one other principal of said principal set.

7. The method of claim 1 wherein each resource of said resource set is a member of only one other resource of said resource set.

8. The method of claim 1 further comprising:
if one candidate access right of said set of candidate access rights is to said specific principal on said particular resource, providing access in accordance with said one candidate access right.

9. An article of manufacture comprising a computer usable medium embodying one or more instructions executable by a computer for performing a method of resolving access to a specific principal on a particular resource, said method comprising:
determining a set of one or more candidate access rights based on at least one grant to at least one principal on at least one resource, wherein a principal set comprises said specific principal and any principals of which said specific principal is a member either directly or indirectly, and a resource set comprises said particular resource and any resources of which said particular resource is a member either directly or indirectly, each candidate access right being to one of said principals of said principal set on one of said resources of said resource set;
eliminating from said set of candidate access rights any candidate access right for which there is another candidate access right to a same principal on a resource which is closer to said particular resource along a same route to said particular resource;
eliminating from said set of candidate access rights any candidate access right for which there is another candidate access right on a same resource to a principal which is closer to said specific principal along a same route to said specific principal; and
providing access in accordance with a most permissive access level of said set of candidate access rights.

10. The article of manufacture of claim 9 wherein said eliminating from said set of candidate access rights any candidate access right for which there is another candidate access right to a same principal on a resource which is closer to said particular resource along a same route to said particular resource is based on a resource closeness; and
wherein said eliminating from said set of candidate access rights any candidate access right for which there is another candidate access right on a same resource to a principal which is closer to said specific principal along a same route to said specific principal is based on a principal closeness.

11. The article of manufacture of claim 10, further comprising:
determining, for each principal of said principal set, said principal closeness of that principal to said specific principal; and
determining, for each resource of said resource set, said resource closeness of that resource to said particular resource.

12. The article of manufacture of claim 9 wherein each principal comprises one from a group consisting of a specific user and an access group, and each resource comprises one from a group consisting of a particular object and a collection.

13. The article of manufacture of claim 9 wherein each principal comprises one from a group consisting of a specific user, an access group and public, and each resource comprises one from a group consisting of a particular object, a collection and all objects.

14. The article of manufacture of claim 9 wherein said method further comprises:
if one candidate access right of said set of candidate access rights is to said specific principal on said particular resource, providing access in accordance with said one candidate access right.

15. The article of manufacture of claim 9 wherein each principal of said principal set is a member of only one other principal of said principal set.

16. The article of manufacture of claim 9 wherein each resource of said resource set is a member of only one other resource of said resource set.

17. A computer system to resolve access to a specific principal on a particular resource, comprising:
a processor; and
a memory storing one or more instructions, executable by said processor, that:
determine a set of one or more candidate access rights based on at least one grant to at least one principal on at least one resource, wherein a principal set comprises said specific principal and any principals of which said specific principal is a member either directly or indirectly, and a resource set comprises said particular resource and any resources of which said particular resource is a member either directly or indirectly, each candidate access right being to one of said principals of said principal set on one of said resources of said resource set;
eliminate from said set of candidate access rights any candidate access right for which there is another candidate access right on a same resource to a principal which is closer to said specific principal along a same route to said specific principal;
eliminate from said set of candidate access rights any candidate access right for which there is another candidate access right on a same principal to a resource which is closer to said particular resource along a same route to said particular resource; and
provide access in accordance with a most permissive access level of said set of candidate access rights.

18. The article of manufacture of claim 17 wherein each principal of said principal set is a member of only one other principal of said principal set.

19. The article of manufacture of claim 17 wherein each resource of said resource set is a member of only one other resource of said resource set

20. The article of manufacture of claim 18 wherein each principal comprises one from a group consisting of a specific user, an access group and public, and each resource comprises one from a group consisting of a particular object, a collection and all objects.
